(19) United States
(12) Patent Application Publication
(10) Pub. No.: US 2026/0191312 A1
(43) Pub. Date: Jul. 9, 2026

(54) PORTABLE PERFUME DISPENSER FOR BOTH APPLICATION AND BUBBLE DIFFUSION

(71) Applicants: Sung Koo Im, Busan (KR); Seok Hyun Im, Busan (KR); IPOROUS Co., Ltd, Busan (KR)

(72) Inventors: Sung Koo Im, Busan (KR); Seok Hyun Im, Busan (KR)

(73) Assignees: Sung Koo Im, Busan (KR); Seok Hyun Im, Busan (KR); IPOROUS Co., Ltd, Busan (KR)

(21) Appl. No.: 19/133,156

(22) PCT Filed: May 8, 2024
(86) PCT No.: PCT/KR2024/006129

§ 371 Date: May 27, 2025

(30) Foreign Application Priority Data
May 11, 2023 (KR) 10-2023-0061353

(51) Int. Cl. A45D 34/02; A45D 34/04

(52) U.S. Cl. CPC A45D 34/02; A45D 34/04; A45D 2200/056; A45D 2200/057; A45D 2200/1018

(57) ABSTRACT

A portable perfume dispenser for both application and bubble diffusion includes a perfume reservoir, a flow channel support communicating with one side of the perfume reservoir, a water pump mounted within the flow channel support, a nozzle connected to one end of the water pump, a spraying section having a spray outlet in fluid communication with the nozzle, a connector defining an internal connecting space and linking an upper portion of the flow channel support with a lower portion of the spraying section, a porous applicator fixed to one end of the spraying section and having a holding space to space the applicator apart from the spray outlet, an air pump surrounding the flow channel support while defining an air space therebetween, and a detachable cap housing spaced apart from the applicator and enclosing an external surface of the air pump while surrounding the flow channel support.

### TECHNICAL FIELD

The present invention relates to a portable perfume dispenser for both application and bubble diffusion. More particularly, the present invention relates to a portable perfume dispenser that addresses conventional limitations and enables the use of liquid perfume without altering its formulation, allows for refilling and replacement, and generates fragrance bubbles formed in a structure optimized for adhesion to the skin and smooth application. The dispenser enables the user to either apply liquid perfume to the body or diffuse the fragrance by generating scented bubbles on a surface.

### BACKGROUND ART

The Korean perfume market has grown by over 30% in four years, from approximately 600 billion KRW in 2019 (pre-COVID-19) to around 800 billion KRW in 2023.

It is projected to reach a scale of 1 trillion KRW by 2025.

The COVID-19 pandemic has played a dominant role in this rapid market expansion. First, prolonged social distancing and isolation have led to increased cases of depression and lethargy—often referred to as “Corona Blue”—prompting individuals to turn to pleasant scents for emotional relief and mood enhancement.

Second, as mask-wearing became commonplace, demand for color cosmetics declined, while the number of consumers expressing their individuality through unique fragrances increased.

Traditionally, the market has been dominated by spray-type liquid perfumes in glass bottles. However, as the user base has diversified and perfume use has become more casual and time-and-location-independent, perfumes designed for convenience in use and portability have been introduced.

In spray-type perfumes, the perfume is dispensed as fine droplets through a narrow outlet. Users cannot easily control the amount or direction of spray, which can result in excessive application or misdirected spraying.

As a result, users may have to go through the inconvenience of washing off excess perfume from their skin.

Moreover, the spraying action inherently spreads liquid droplets, making localized application on the skin difficult.

Since alcohol constitutes the majority of perfume formulations, it directly contacts the skin upon spraying, which may cause irritation. Additionally, fine droplets may disperse into the air and be inhaled by the user.

To address these issues, solid perfumes and roll-on perfumes have been developed. Solid perfumes are formulated by mixing fragrances with wax or oil bases into balm, cream, or stick forms. These formulations eliminate concerns about leakage during transport, and unlike alcohol-based perfumes, they evaporate more slowly, reducing the need for strict sealing.

In addition, such slower volatility allows the fragrance molecules to linger longer, enhancing scent longevity and providing a more subtle diffusion.

In addition, since they are not alcohol-based, these perfumes are also suitable for users sensitive to alcohol.

However, due to their slow evaporation, these perfumes tend to have weaker projection. Additionally, when applied, wax or oil residues remain on the skin, which can cause a sticky rather than refreshing sensation.

Roll-on perfumes address the portability issue of spray-type perfumes by incorporating a rollerball at the bottle's opening. A small gap between the rollerball and the bottle opening allows controlled application and dosage, making them convenient for targeted use.

However, the amount dispensed is relatively small compared to spray types, resulting in weaker diffusion. If the rollerball is not tilted downward, the perfume may not dispense, making it difficult to apply to certain areas.

In addition, when oil is used as the base to improve diffusion, repeated use may cause dust and other foreign matter to accumulate on the oil-coated rollerball, impairing its rotation and hygiene.

### DISCLOSURE OF INVENTION

### Technical Problem

The present invention has been devised to resolve the above-described problems and needs. The objective of the invention is to provide a portable perfume dispenser for both application and bubble diffusion that enables the use of liquid perfume without altering its formulation, allows for refilling and replacement, and generates fragrance bubbles formed in a structure optimized for adhesion to the skin to enhance applicability. The dispenser makes it possible to apply liquid perfume directly to the body or to enjoy fragrance emitted from fragrance bubbles generated on a surface.

### Technical Solution

To achieve the above objective, a portable perfume dispenser for both application and bubble diffusion according to an embodiment of the present invention relates to a device, capable of diffusing fragrance either by surface application or by holding the fragrance in bubbles, including: a perfume reservoir configured to store liquid perfume; a flow channel support in communication with one side of the perfume reservoir; a water pump mounted within the flow channel support and configured to pump the liquid perfume; a nozzle connected to one end of the water pump; a spraying section having a spray outlet in fluid communication with the nozzle; a connector defining an internal connecting space and connecting an upper portion of the flow channel support to a lower portion of the spraying section; a porous applicator fixed to one end of the spraying section and having a holding space that is spaced apart from the spray outlet; an air pump configured to pump air, the air pump surrounding the flow channel support while forming an air space therebetween; and a detachable cap housing spaced apart from the applicator, the cap housing enclosing an outer surface of the air pump and surrounding the flow channel support.

### Advantageous Effects

According to the present invention, liquid perfume can be used without altering its formulation, while allowing for convenient refilling and replacement, thereby addressing the limitations of conventional devices.

In addition, fragrance bubbles can be generated in a form optimized for adhesion to the skin, enabling effective application and prolonged fragrance retention.

Moreover, the fragrance bubbles are not detached from the porous applicator. Instead, when pressure is applied, only a portion of the bubbles is released to the outside, and when the pressure is released, the bubbles reabsorb into the applicator. As a result, fragrance is emitted only from the exposed portion, thereby minimizing perfume consumption.

In addition, unlike conventional spray-type perfumes that result in excessive and inefficient usage—particularly when the pressure decreases—the present invention enables precise control over the degree of pressurization, significantly reducing unnecessary consumption.

### BRIEF DESCRIPTION OF THE DRAWINGS

FIG. 1 is a perspective view illustrating the appearance of a portable perfume dispenser for both application and bubble diffusion according to an embodiment of the present invention.

FIG. 2 is a cross-sectional view showing the interior of part (a) of FIG. 1.

FIG. 3 is a cross-sectional view showing the interior of part (b) of FIG. 1.

FIG. 4 is an exploded perspective view of the portable perfume dispenser for both application and bubble diffusion according to an embodiment of the present invention.

FIG. 5 is a perspective view illustrating the appearance of a portable perfume dispenser for both application and bubble diffusion according to another embodiment of the present invention.

FIG. 6 is a cross-sectional view showing the interior of part (a) of FIG. 5.

FIG. 7 is a cross-sectional view showing the interior of part (b) of FIG. 5.

FIG. 8 is an exploded perspective view of the portable perfume dispenser for both application and bubble diffusion according to another embodiment of the present invention.

### BEST MODE FOR INVENTION

The present invention is capable of various modifications and having multiple embodiments. Specific embodiments are illustrated in the drawings and described in detail herein.

However, these are not intended to limit the invention to the particular forms disclosed. Rather, the invention is to cover all modifications, equivalents, and alternatives falling within the scope of the invention.

When an element is described as being “connected” or “coupled” to another element, it may be directly connected or coupled to the other element or may be indirectly connected or coupled with intervening elements.

In contrast, when an element is described as being “directly connected” or “directly coupled” to another element, there are no intervening elements between them.

The terminology used herein is for the purpose of describing particular embodiments only and is not intended to be limiting of the invention. As used herein, the singular forms include the plural forms as well unless the context clearly indicates otherwise.

The terms “include,” “comprise,” “have,” and any variations thereof are intended to cover non-exclusive inclusions. For example, a composition, method, or apparatus that includes a list of elements is not necessarily limited to only those elements, but may include other elements not expressly listed or inherent to such composition, method, or apparatus.

Terms such as “first,” “second,” and the like may be used to describe various elements, but such terms should not be construed as limiting. These terms are used only to distinguish one element from another.

In addition, the term “unit” or “section” used in the specification refers to a component that performs at least one function or operation, and may be implemented by hardware, software, or a combination thereof.

Additionally, the components described in the embodiments with reference to the accompanying drawings are not limited to the specific embodiments and may be applied to other embodiments as long as the technical scope of the present invention is maintained. It is also understood that, even if not explicitly stated, multiple embodiments may be combined and implemented as a single embodiment.

Additionally, in the description with reference to the drawings, the same or similar reference numerals are used for elements having the same or similar functions, and repeated descriptions thereof will be omitted for clarity.

In describing the present invention, detailed descriptions of related known technologies may be omitted when it is deemed that such descriptions would unnecessarily obscure the subject matter of the present invention.

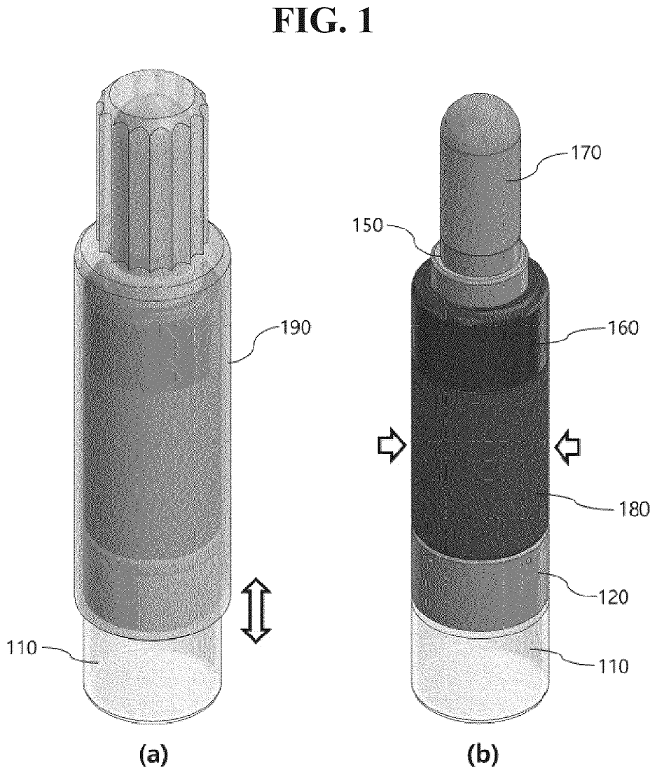

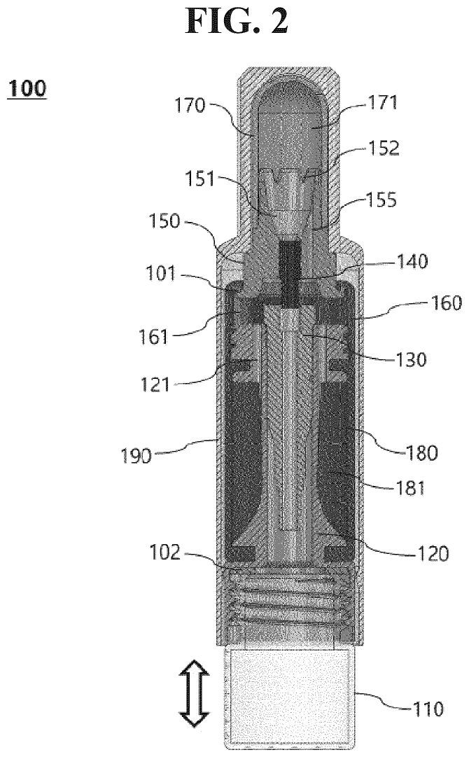

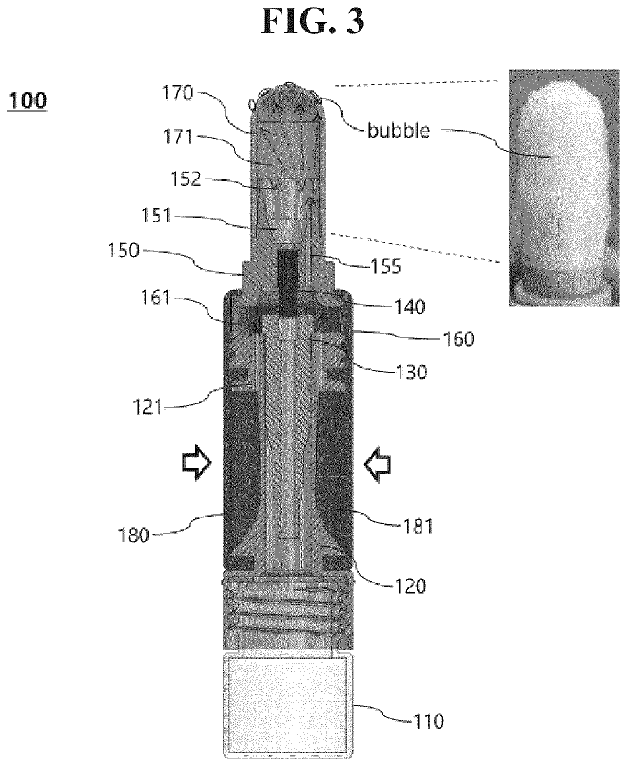

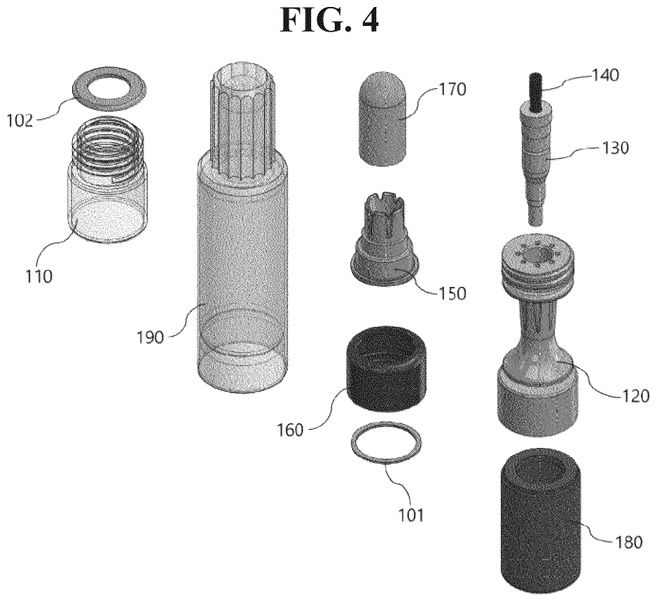

FIG. 1 is a perspective view illustrating the appearance of a portable perfume dispenser for both application and bubble diffusion according to an embodiment of the present invention. FIG. 2 is a cross-sectional view showing the interior of part (a) of FIG. 1, FIG. 3 is a cross-sectional view showing the interior of part (b) of FIG. 1, and FIG. 4 is an exploded perspective view of the portable perfume dispenser according to the same embodiment.

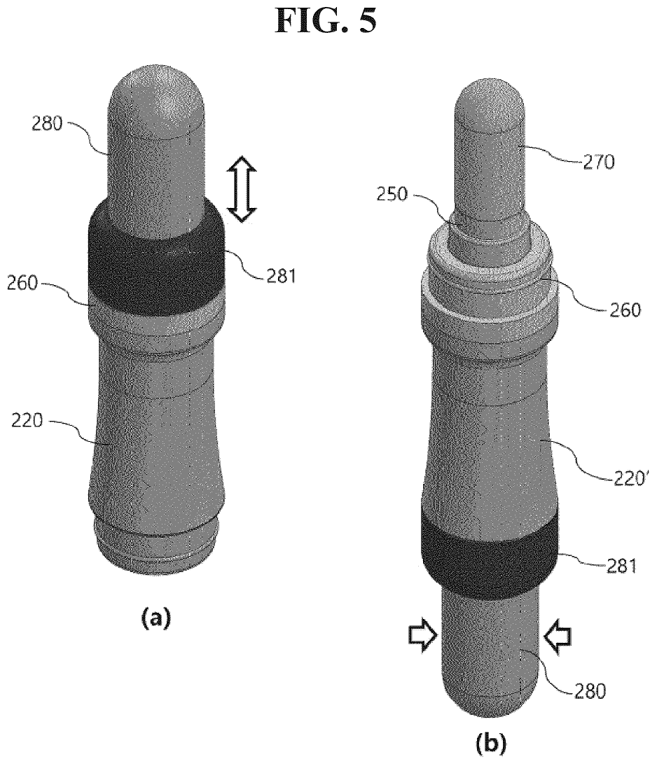

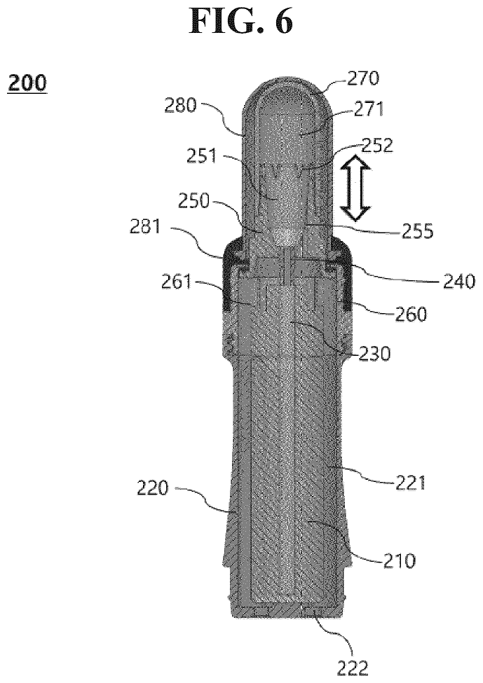

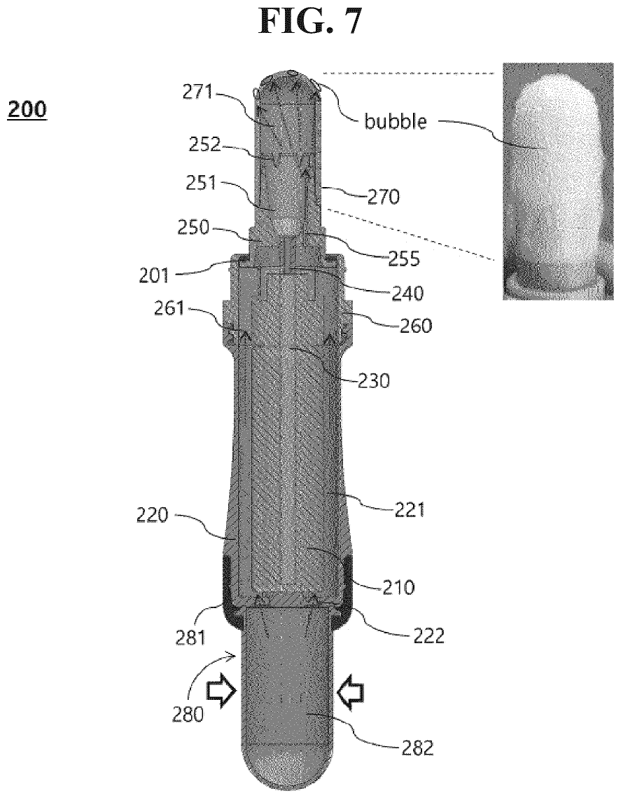

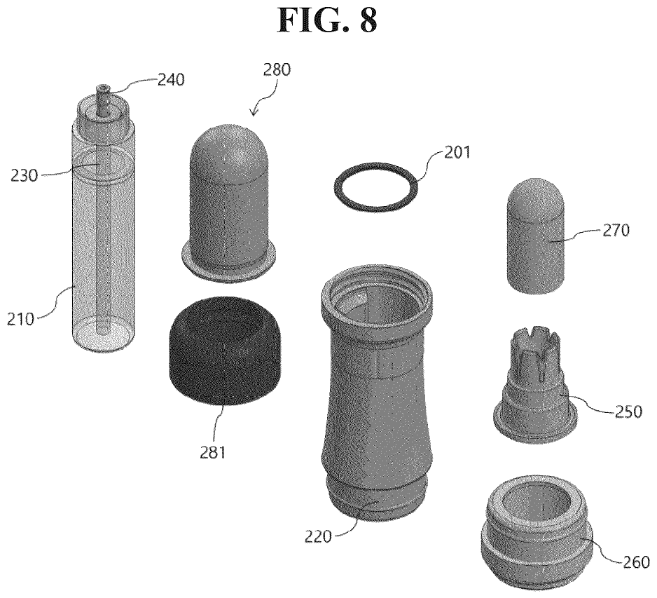

FIG. 5 is a perspective view illustrating the appearance of a portable perfume dispenser for both application and bubble diffusion according to another embodiment of the present invention. FIG. 6 is a cross-sectional view showing the interior of part (a) of FIG. 5, FIG. 7 is a cross-sectional view showing the interior of part (b) of FIG. 5, and FIG. 8 is an exploded perspective view of the portable perfume dispenser according to the other embodiment.

In this regard part (a) of FIG. 1 shows a state in which the cap housing 190 is closed, and part (b) of FIG. 1 shows a state in which the cap housing 190 is removed to expose the internal structure.

Likewise, part (a) of FIG. 5 shows a state in which the dual-function air cap 280 is closed, and part (b) of FIG. 5 shows a state in which the dual-function air cap 280 is detached and mounted to the lower portion of the housing section 220.

Referring to the drawings described above, a portable perfume dispenser 100 for both application and bubble diffusion according to an embodiment of the present invention is a device, which is capable of diffusing fragrance either by surface application or by holding the fragrance in bubbles, including: a perfume reservoir 110 configured to store liquid perfume; a flow channel support 120 communicating with one side of the perfume reservoir 110; a water pump 130 mounted within the flow channel support 120 and configured to pump the liquid perfume; a nozzle 140 connected to one end of the water pump 130; a spraying section 150 having a spray outlet 151 formed in fluid communication with the nozzle 140; a connector 160 defining an internal connecting space 161 and linking an upper portion of the flow channel support 120 to a lower portion of the spraying section 150; a porous applicator 170 fixed to one end of the spraying section 150 and having a holding space 171 spaced apart from the spray outlet 151; an air pump 180 configured to pump air, the air pump 180 surrounding the flow channel support 120 while defining an air space 181 therebetween; and a detachable cap housing 190 spaced apart from the applicator 170 and enclosing an outer surface of the air pump 180 while surrounding the flow channel support 120.

In addition, when one of the perfume reservoir 110 and the cap housing 190 is fixed and the other is repeatedly pressed (or when the perfume reservoir 110 supported by the cap housing 190 is repeatedly pressed), the water pump 130 connected via the flow channel support 120 is actuated to pump the liquid perfume stored in the perfume reservoir 110, thereby discharging the perfume through the spray outlet 151. The discharged perfume is deposited on an inner surface of the applicator 170 and wets an outer surface of the applicator 170 through pores of the applicator 170.

In addition, when the air pump 180 exposed from the cap housing 190 is repeatedly pressed, air in the air space 181 may be discharged into the holding space 171 through an air hole 155 formed at one side of the spraying section 150, and, together with perfume droplets deposited on an inner surface of the applicator 170, pass through pores of the applicator 170, thereby generating and releasing bubbles containing vaporized perfume on an outer surface of the applicator.

In addition, the perfume reservoir 110 may be detachably coupled to one side of the flow channel support 120.

In addition, the flow channel support 120 may have an air path hole 121 formed along an outer longitudinal direction thereof to communicate with the air space 181.

The air pump 180 may have a flexible, expandable doughnut-shaped structure.

A portable perfume dispenser 200 for both application and bubble diffusion according to another embodiment of the present invention is a device, which is capable of diffusing fragrance either by surface application or by holding the fragrance in bubbles, including: a perfume reservoir 210 configured to store liquid perfume; a housing section 220 covering an outer side of the perfume reservoir 210, wherein an airflow path 221 extending in a longitudinal direction is defined between the housing section 220 and the perfume reservoir 210; a water pump 230 mounted within the perfume reservoir 210 and configured to pump the liquid perfume; a nozzle 240 connected to one end of the water pump 230; a spraying section 250 having a spray outlet 251 formed in fluid communication with the nozzle 240; a connector 260 defining a connection space 261 and connecting an upper portion of the housing section 220 to a lower portion of the spraying section 250; a porous applicator 270 fixed to one end of the spraying section 250 and having a holding space 271 to space the applicator 270 apart from the spray outlet 251; and a dual-function air cap 280 including a cap ring 281 detachably positioned at an upper side of the connector 260, the dual-function air cap 280 surrounding the applicator 270 while being spaced apart from the applicator 270.

In addition, when the dual-function air cap 280, supported by the housing section 220 surrounding the perfume reservoir 210, is repeatedly pressed, the water pump 230 connected in association with the perfume reservoir 210 is actuated to pump the liquid perfume stored in the perfume reservoir 210. The perfume is discharged through the spray outlet 251, deposited on an inner surface of the applicator 270, and wets an outer surface of the applicator 270 through pores of the applicator 270.

In addition, when the dual-function air cap 280 is repeatedly pressed after being detached and then coupled to a lower portion of the housing section 220, air may flow along the airflow path 221 and be discharged into the holding space 271 through an air hole 255 formed at one side of the spraying section 250, and, together with perfume droplets deposited on an inner surface of the applicator 270, pass through pores of the applicator 270, thereby generating and releasing bubbles containing vaporized perfume on an outer surface of the applicator 270.

A tip of the dual-function air cap 280 may have a flexible capsule shape and be expandable and contractible.

The spray outlet 151 or 251 of the spraying section 150 or 250 has a tubal shape, and a branched groove 152 or 252 is formed at a distal end of the spray outlet 151 or 251 so as to divide into more than one branch.

The applicator 170 or 270 may have pores with a size in a range of 5 μm to 150 μm.

The applicator 170 or 270 may include a hollow dome-shaped tip that extends linearly.

The applicator 170 or 270 may be made of one or more materials selected from porous plastic, porous ceramic, porous rubber, and porous fiber.

A packing member 101 or 201 may be interposed between the spraying section 170 or 270 and the connector 160 or 260 to provide sealing.

The liquid perfume may include essential oil, aroma oil, or a liquid having fragrance.

Hereinafter, the configuration and operation of the portable perfume dispensers 100 and 200 for both application and bubble diffusion according to the embodiments of the present invention will be described in detail.

The present invention provides portable perfume dispensers 100 and 200, which address the problems of the prior art and allow the perfume to be used in its original formulation without alteration. The dispensers are refillable and replaceable, and include a component configured to generate fragrance bubbles optimized for application by closely adhering to the skin.

The portable perfume dispenser 100 for both application and bubble diffusion according to an embodiment of the present invention relates to a device configured to apply perfume to a surface or to diffuse fragrance via bubbles. As illustrated in FIGS. 1 to 4, the dispenser generally includes a perfume reservoir 110, a flow channel support 120, a water pump 130, a nozzle 140, a spraying section 150, a connector 160, a porous applicator 170, an air pump 180, and a cap housing 190.

As shown in FIGS. 2 and 3, the perfume reservoir 110 is a container configured to store liquid perfume and may have various shapes suitable for containing liquids such as perfume.

The perfume reservoir 110 is airtightly connected to the flow channel support 120, enabling the water pump 130 to deliver the liquid perfume from within the reservoir 110 to the upper portion, namely the nozzle 140.

That is, the perfume reservoir 110 serves as a vessel for containing liquid perfume and may be detachably coupled to one side of the flow channel support 120 to establish fluid communication.

The upper portion of the perfume reservoir 110 is hermetically coupled to the lower portion of the flow channel support 120 by means such as screw fastening or press fitting, thereby preventing unnecessary loss of perfume.

Here, a sealing member 102, such as an elastic O-ring, may be installed inside the upper portion of the perfume reservoir 110 to ensure airtight sealing.

In other words, the sealing member 102 is interposed between the perfume reservoir 110 and the flow channel support 120 to enable a hermetic seal therebetween.

In addition, the perfume reservoir 110 may be made of glass or an engineering plastic such as polycarbonate (PC) to prevent deterioration of the perfume. In order to prevent damage to the glass during transportation, the reservoir may be specially treated or made from reinforced glass.

The flow channel support 120 communicates with one side of the perfume reservoir 110 and serves as a conduit through which the liquid perfume in the perfume reservoir 110 is delivered to the water pump 130, while also supporting the water pump 130.

That is, as illustrated in FIG. 4 and the like, the flow channel support 120 may have a hollow cylindrical shape that is radially constricted with a recessed center. The lower end may be open to allow refilling from the perfume reservoir 110 and may be connected in fluid communication therewith.

In addition, the flow channel support 120 may be detachably coupled to the perfume reservoir 110 by means of a threaded inner surface, allowing separation or fastening as needed.

In addition, as illustrated in FIG. 2 and the like, the flow channel support 120 may have an air path hole 121 formed along an outer longitudinal direction thereof, allowing communication with the air space 181.

As shown in FIGS. 2 and 3, the water pump 130 is a device configured to pump liquid and may be mounted within the perfume reservoir 110 to pump liquid perfume.

In particular, the term “water pump” 130 is used for intuitive understanding and is not intended to limit the pumped fluid to water. The water pump may be capable of pumping various types of liquids, including but not limited to liquid perfume.

Here, the water pump 130 may be installed in the perfume reservoir 110 with its upper portion sealed, and may include an elastic material such as a spring (not shown) along the nozzle 140, thereby allowing vertical expansion and contraction of the pump and enabling it to pump the liquid perfume.

Additionally, since the water pump 130 is sealed in the same manner as a conventional perfume bottle, with only the nozzle 140 positioned inside the spraying section 150, even if the applicator 170 is exposed to air, the perfume absorbed into the applicator 170 is the only portion that is released, and the perfume stored in the perfume reservoir 110 remains preserved.

Therefore, unlike simply spraying perfume into the air, the water pump 130 optimizes both sealing performance and applicability.

As illustrated in FIGS. 2 and 3, the nozzle 140 is connected to one end of the water pump 130 and engaged with a lower portion of the spraying section 150, thereby functioning to appropriately deliver the liquid perfume pumped by the water pump 130 into the spraying section 150.

In other words, the nozzle 140 works in conjunction with the water pump 130 and is connected to the spray outlet 151 to allow vertical movement during pumping.

In addition, the nozzle 140 is a pipe-shaped mechanical element used to control characteristics of a flowing fluid—such as flow rate, velocity, direction, and pressure—so as to determine the direction of flow of the perfume.

As shown in FIGS. 2 and 3, the spraying section 150 supports and secures the lower part of the applicator 170, and is tightly coupled with the nozzle 140 connected to the water pump 130 which transfers and sprays the perfume inside. The spray outlet 151 is formed in a conical or trumpet-like shape, in which the lower part is narrower and the upper part is wider, so that the perfume can be optimally discharged toward the upper end.

However, the spray outlet 151 is not limited to any specific shape and may adopt various configurations suitable for optimal discharge.

Additionally, a wedge-shaped branched groove 152 may be formed at the distal end of the spray outlet 151 of the spraying section 150, which may take the shape of a flower calyx and be divided into more than one branch.

That is, as shown in FIGS. 2 and 3, the branched groove 152 may be formed such that its upper part is divided into more than one section, while the lower part remains integrated to form a cylindrical shape.

In addition, the branched groove 152 allows perfume that fails to be immediately absorbed into the applicator 170 during spraying and instead flows downward along the inner wall of the applicator 170 to be quickly dispersed through multiple spray outlet branches at the top of the spray outlet 151 and absorbed completely.

However, the branched groove 152 is not limited to any particular shape and may adopt various configurations that allow optimal dispersion and absorption of the perfume.

The spraying section 150 may include the spray outlet 151 which is in fluid communication with the nozzle 140 and configured to spray, and a wedge-shaped branched groove 152 formed such that the spray outlet 151 has a trumpet-like shape and divides into more than one branch at its distal end.

In addition, the spraying section 150 may include an air hole 155, which serves as an air flow path to allow air supplied from the air pump 180 to pass through.

That is, when the air pump 180 is pressed by hand, the pressurized air inside the air pump 180 passes through the air path hole 121, which is formed along the outer longitudinal direction of the flow channel support 120, and enters the internal connecting space 161 of the connector 160. The air is then guided through the air hole 155, which is an air path within the spraying section 150, to reach the applicator 170.

As illustrated in FIGS. 2 to 4, the connector 160 is a coupling member that connects an upper portion of the flow channel support 120 to a lower portion of the spraying section 150 and defines an internal connecting space 161.

That is, the connector 160 connects and secures the flow channel support 120 and the spraying section 150 in a sealed manner, and provides the internal connecting space 161 therein.

Here, the connector 160 ensures airtight coupling of the flow channel support 120 and the spraying section 150 so that pressurized air from the air pump 180 can be reliably delivered through the connecting space 161 to the applicator 170.

In addition, to achieve sealing without gaps between the lower end of the spraying section 150 and the upper inner portion of the connector 160, an elastic sealing member 101 such as an O-ring may be interposed or embedded therein to prevent leakage of liquid or gas.

As illustrated in FIGS. 2 to 4, the porous applicator 170 is a porous application member fixed to one end of the spraying section 150, with a holding space 171 formed to be spaced apart from the spray outlet 151.

That is, the applicator 170 is made of a porous material capable of absorbing and retaining perfume, thereby enabling smooth transfer to the skin. Even upon repeated contact with the skin, the applicator 170 is resistant to deformation or deterioration and may be formed of porous plastic, porous ceramic, porous rubber, or porous fiber, all of which are physically and chemically biocompatible.

Among them, porous plastics such as porous polyethylene (PE) and porous polyurethane (PU) may be suitable for the given conditions.

The shape of the applicator 170 may be implemented in various forms, such as a bell shape or spindle shape, as long as it is suitable for application. It may also be replaceable by being separable from the connector 160.

In addition, the applicator 170 may have a hollow internal structure and a predetermined thickness optimized for absorbing and releasing the perfume.

Specifically, the applicator 170 includes a dome-shaped tip with a hollow interior that extends linearly, providing a user-friendly structure for application, and the pore size is preferably maintained within a range of 5 μm to 150 μm.

In reference, it is noted that, based on internal testing, the applicator 170 satisfied conditions such as application uniformity and bubble formation when the pore size was within the range of 5 μm to 150 μm.

The applicator 170 may be made of one or more materials selected from porous plastic, porous ceramic, porous rubber, and porous fiber.

As shown in FIGS. 2 and 3, the air pump 180 is a device configured to pump and supply air, and forms an air space 181 by surrounding the flow channel support 120 to facilitate the pumping of air.

Additionally, the air pump (180) has either a flexible doughnut shape or a hollow cylindrical shape, which covers the flow channel support (120). As the air pump is located near the perfume reservoir (110) that contains the portable perfume, the air pump is able to be involved with the creation of fragrance bubbles.

In other words, to maximize portability and operability of the portable perfume dispenser, the air pump 180 may be airtightly coupled to an unused space around the flow channel support 120.

Here, when the air pump 180 is manually pressed, the pressurized air therein passes through the air path hole 121, which is a vertical air passage formed along the outer longitudinal direction of the flow channel support 120, and enters the internal connecting space 161 of the connector 160. The air is then guided through the air hole 155 in the spraying section 150 and delivered into the holding space 171 inside the applicator 170.

In addition, the air delivered is discharged through the pores to the outside of the applicator 170 and simultaneously carries the perfume within the pores into the air.

At this time, the connector 160 is airtightly joined with the flow channel support 120 and the spraying section 150, allowing the pressurized air from the air pump 180 to be completely transferred to the applicator 170 through the air flow path.

At this time, due to the pressurization speed, the perfume may be expelled through the pores in the form of bubbles, thereby generating fragrance bubbles.

As the pressurization speed increases, the diffusion speed of the perfume may also increase.

Additionally, depending on the material or hardness of the air pump 180, an air vent (not shown) may be further formed on the surface of the air pump 180 to allow smooth return after releasing pressure.

Fragrance bubbles contribute to enhancing scent diffusion by promoting the dispersion of fragrance particles more effectively than liquid perfume similar to the fine droplets produced in a spray.

In addition, the fragrance bubbles do not separate from the applicator 170, only a portion of the bubbles is exposed when pressed, and upon pressure release, the bubbles reabsorb into the applicator 170, allowing fragrance to be emitted only from the exposed area.

Accordingly, unnecessary consumption of perfume is significantly reduced compared to spray-type dispensers, and unlike sprays whose efficiency drops with reduced pressure, the degree of pressurization can be freely adjusted.

Because the perfume contained inside the applicator 170 is also exposed externally through pressurization, application is performed only on the outer surface of the applicator 170 and this prevents the problem of perfume loss into the air when not in use, ensuring complete usage of the internal perfume.

Additionally, pores may be formed in the applicator 170 to allow the direct diffusion of fragrance particles without generating fragrance bubbles.

When the applicator 170 with fragrance bubbles is applied to the skin, the fragrance particles in bubble form are finely applied rather than in liquid form. This provides significantly superior spreadability compared to solid or liquid-based perfumes such as solid perfumes or roll-on types, allowing the same scent strength and diffusion area to be achieved with a smaller amount.

As shown in FIGS. 2 and 3, the cap housing 190 is spaced apart from the applicator 170, surrounds the outer surface of the air pump 180 and the flow channel support 120, and is configured to be detachable.

In other words, the cap housing 190 is a cover member configured to completely cover the applicator 170 in order to minimize unnecessary evaporation of the absorbed perfume during periods of non-use.

In addition, the cap housing 190 may have an exterior design that not only covers the applicator 170 but also caps all other parts except the perfume reservoir 110, which needs to be checked for the amount of perfume, thereby enhancing a perfume-like image.

In addition, the cap housing 190 may be aesthetically varied in design to represent different perfume image styles.

In summary, to ensure stable perfume dispensing, the dispenser may be inverted such that the applicator 170 is positioned at the lower side and the perfume reservoir 110 is on top. Repeatedly pressing the perfume reservoir 110 in this orientation can induce absorption of perfume into the applicator 170.

In this configuration, the cap housing 190 covering from the applicator 170 to the perfume reservoir 110 may be fixed to the lower end of the spraying section 150. When the perfume reservoir 110 is pressed, vertical movement of the water pump 130 may be achieved.

Alternatively, without inverting the device, a connecting tube may be inserted into the perfume reservoir 110, allowing the perfume to be directly delivered from the perfume reservoir 110 to the applicator 170 by pressing the applicator 170 or the cap housing 190 that covers the applicator.

For example, rather than the perfume being unevenly dispersed into the air as in spray-type systems, the applicator 170, which covers the spray outlet 151, absorbs the perfume. Once the applicator 170 has appropriately absorbed the perfume, it can evenly apply the fragrance to the user's skin or fabric through its micro-pores, or gently diffuse it into the air.

Even when an excessive amount of perfume is delivered to the applicator 170 due to excessive pumping, the porous applicator 170 can retain the perfume stably due to its sufficient absorption capacity, thereby minimizing leakage and unnecessary loss.

In addition, as the perfume released through the dense micro-pores of the applicator 170 adheres thinly to the surface, it spreads as if it were being applied with a brush, resulting in excellent spreadability. This makes it suitable for application not only to the skin but also to the hair and various types of fabric.

The applicator 170 may have a user-friendly shape such as a bell or spindle shape that facilitates application to the body, and since it retains the absorbed perfume for an extended time, it allows for application to any area or direction, unlike spray-type or roll-on perfumes.

In addition, the fragrance components are retained within the pores of the applicator 170, which prevents rapid evaporation and allows only the alcohol to evaporate, so that fragrance particles are deposited on the skin only during application.

In addition, the micro-pores of the applicator 170 and the action of rubbing it against the skin selectively facilitate the rapid evaporation of alcohol and promote the diffusion of fragrance particles.

As the alcohol quickly evaporates, it enhances the refreshing sensation while reducing irritation.

The pores of the applicator 170 are dense enough to retain perfume and fine enough to allow easy application to parts of the body. The optimal pore size can be adjusted according to the shape, size, and thickness of the applicator 170.

Meanwhile, in the present invention, the portable perfume may instead hold an aromatic solution such as essential oil in the perfume reservoir 110. The solution can be absorbed into the applicator 170 and applied topically to the skin or inhaled, thereby allowing for simplified aromatherapy.

Since aromatic solutions typically contain highly concentrated pharmacological components, applying an appropriate amount can be beneficial to the human body. The applicator 170 with fine pores allows for localized application to specific areas, and indirect inhalation through the pores or fragrance bubbles of the applicator, rather than direct inhalation, reduces harm and enhances utility.

Moreover, the applicator 170 may also be used as a diffuser by absorbing the fragrance liquid and releasing it into the air via natural evaporation or fan-driven airflow.

In addition, although the present invention refers to “perfume,” aqueous liquids containing fragrance materials may also be used. In this case, the applicator 170 may be rendered hydrophilic or include hydrophilic materials to enable the application of water-based liquids.

That is, the portable perfume included in the present invention is applicable to any liquid that has a fragrance.

Accordingly, in a portable perfume dispenser 100 according to an embodiment of the present invention, when the perfume reservoir 110 supported by the cap housing 190 is repeatedly pressed, the water pump 130 is pumped through the flow channel support 120 connected to the perfume reservoir 110, thereby discharging the perfume stored in the perfume reservoir 110 through the spray outlet 151, depositing it on an inner surface of the applicator 170, and wetting an outer surface of the applicator 170 through its pores so that the perfume can be applied or transferred to the skin or hair.

In addition, when the air pump 180 exposed from the cap housing 190 is repeatedly pressed in the portable perfume dispenser 100, the air stored in the air space 181 is discharged into the holding space 171 through an air hole 155 formed at one side of the spraying section 150. The discharged air, together with perfume droplets deposited on an inner surface of the applicator 170, passes through the pores of the applicator 170, thereby generating and releasing bubbles on an outer surface of the applicator 170, the bubbles containing vaporized perfume.

A perfume dispenser 200 according to another embodiment of the present invention is a device configured to apply perfume to a surface or diffuse fragrance via bubbles, and as shown in FIGS. 5 to 8, the dispenser generally includes a perfume reservoir 210, a housing section 220, a water pump 230, a nozzle 240, a spraying section 250, a connector 260, a porous applicator 270, and a dual-function air cap 280.

The perfume reservoir 210 according to another embodiment of the present invention, as shown in FIGS. 6 and 7, is a container configured to store liquid perfume and may be provided in various shapes suitable for containing liquids such as perfume.

In addition, the perfume reservoir 210 is hermetically protected by the housing section 220 so that the water pump 230 can deliver the perfume from inside the perfume reservoir 210 to the top, i.e., to the nozzle 240.

In addition, the perfume reservoir 210 may be made of a material such as glass or engineering plastics (e.g., polycarbonate (PC)) to prevent the deterioration of the perfume. And, in order to prevent damage to the glass during transport, the glass may be specially treated or replaced with a special material such as tempered glass.

Although the shape of the perfume reservoir 210 differs from that of the perfume reservoir 110 in the previous embodiment, both serve the same or substantially similar function as containers for storing liquid perfume.

The housing section 220, as shown in FIGS. 6 and 7, accommodates the perfume reservoir 210 therein and is a housing member in which an airflow path 221 is formed on the outer side of the perfume reservoir 210.

That is, as shown in FIG. 7, the housing section 220 covers the outer side of the perfume reservoir 210, and an airflow path 221 is formed in the longitudinal direction between the housing section 220 and the perfume reservoir 210 to provide a passage through which air generated by the dual-function air cap 280 can flow.

In addition, as shown in FIGS. 6 and 7, the housing section 220 includes a housing hole 222 formed at a lower portion thereof, through which air generated in the dual-function air cap 280 can pass and enter the airflow path 221.

As shown in FIGS. 6 and 7, the water pump 230 is a pumping device mounted inside the perfume reservoir 210 and configured to pump liquid perfume. Since it is identical or similar to the water pump 130 of the embodiment described above, redundant explanations are omitted.

As shown in FIGS. 6 and 7, the nozzle 240 is connected to one end of the water pump 230 and joined to a lower portion of the spraying section 250. the nozzle 240 functions to appropriately deliver the liquid perfume pumped from the water pump 230 to the spraying section 250.

That is, since the nozzle 240 that interlocks with the water pump 230 is identical or similar to the nozzle 140 of the above-described embodiment, redundant explanations are omitted.

As shown in FIGS. 6 and 7, the spraying section 250 supports and fixes a lower portion of the applicator 270 and is closely joined to the nozzle 240 connected to the water pump 230 that transports and sprays perfume. A spray outlet 251 is formed in a conical or trumpet-like shape that is narrow at the bottom and wide at the top so that the perfume can be optimally sprayed upward.

In addition, a wedge-shaped branched groove 252, which divides into more than one branch, may be formed at the distal end of the spray outlet 251 in the form of a flower calyx.

In addition, the spraying section 250 may include an air hole 255, which serves as an air path through which air supplied from the dual-function air cap 280 can pass.

That is, when a space formed in the dual-function air cap 280 is repeatedly pressed by hand, the pressurized air inside the dual-function air cap 280 is delivered through the airflow path 221 formed in the housing section 220 to the internal connecting space 261 of the connector 260, and then transferred to the applicator 270 via the air hole 255 inside the spraying section 250.

In addition, since the spraying section 250 is identical or similar to the spraying section 150 described in an embodiment of the present invention, redundant explanations are omitted.

As shown in FIGS. 6 to 8, the connector 260 is a connecting member that links an upper portion of the housing section 220 and a lower portion of the spraying section 250, and defines an internal connecting space 261 therein.

That is, the connector 260 connects and secures the housing section 220 and the spraying section 250 in a sealed manner, and an internal connecting space 261 may be formed therein.

In this case, the connector 260 allows the housing section 220 and the spraying section 250 to be hermetically joined, so that pressurized air from the space defined by the housing section 220 and the dual-function air cap 280 can be completely delivered to the applicator 270 through the connecting space 261.

In addition, to provide sealing without any gap with the lower portion of the spraying section 250, an elastic packing member 201 such as an O-ring may be interposed or embedded in the upper interior of the connector 260, thereby preventing leakage of liquid or gas.

In addition, the connector 260 is identical or similar to the connector 160 according to one embodiment of the present invention, and thus, repetitive descriptions are omitted.

As shown in FIGS. 6 to 8, the porous applicator 270 is a porous application member fixed to one end of the spraying section 250 while forming a holding space 271 spaced apart from the spray outlet 251.

That is, the applicator 270 is made of a porous material capable of efficiently absorbing and holding perfume, and smoothly transferring it to the skin. It may be formed of porous plastic, porous ceramic, porous rubber, or porous fiber that causes no deformation or deterioration even after repeated contact with the skin and is physically and chemically harmless to the human body.

Among them, porous plastics such as porous polyethylene (PE) or porous polyurethane (PU) may be suitable depending on the required conditions.

In addition, the applicator 270 may be implemented in various shapes suitable for application, such as bell-shaped or spindle-shaped, and may be detachable and replaceable from the connector 260.

In addition, the applicator 270 may also have a hollow structure with a specific thickness to optimize perfume absorption and emission.

In addition, the applicator 270 is identical or similar to the applicator 170 according to one embodiment of the present invention, and thus, repetitive descriptions are omitted.

As shown in FIGS. 6 and 7, the dual-function air cap 280 is a protective cover member that surrounds the applicator 270 while being spaced apart from the applicator 270, and includes a cap ring 281 detachably coupled to the upper side of the connector 260.

In addition, the dual-function air cap 280 has a flexible capsule-shaped tip that is capable of expansion and contraction, and is connected to the connector 260 while being spaced apart from the applicator 270. The dual-function air cap 280 is detachably coupled to one side of the connector 260 and the cap ring 281.

That is, the dual-function air cap 280 functions as a cover member that fully encloses the applicator 270 in order to minimize unnecessary evaporation of perfume absorbed in the applicator 270 when not in use.

Additionally, the dual-function air cap 280 may be configured to cap the exterior of the applicator 270 while maintaining a spaced relationship, thereby enhancing the visual impression of a typical perfume product.

In addition, the external appearance of the dual-function air cap 280 may be variously designed to express diverse image concepts of perfume products.

Meanwhile, when the dual-function air cap 280 is detached from the connector 260 and then coupled to a lower portion of the housing section 220, the dual-function air cap 280 forms an internal space and performs an air pump function.

That is, the dual-function air cap 280 may be formed of a flexible elastic material to function also as an air pump.

In this case, the dual-function air cap 280 may serve as a cap that seals and protects the applicator 270 when covering the applicator 270, and may also function to supply perfume from the perfume reservoir 210 to the applicator 270 by repeatedly pressing the cap.

As shown in FIG. 7, when acting as an air pump, the dual-function air cap 280 is pressurized while being tightly fixed to the lower end of the portable perfume device. In this state, the housing section 220 may accommodate the entire perfume reservoir 210 so that the water pump 230 can be directly inserted therein.

Air pressurized by the dual-function air cap 280 enters through the housing hole 222, flows along the airflow path 221 formed in the housing section 220, gathers in the connecting space 261 of the connector 260, sequentially passes through the air hole 255 formed in the spraying section 250, and is finally delivered to the applicator 270, thereby generating fragrance bubbles in the applicator 270.

More specifically, when the dual-function air cap 280 is detached from the connector 260 and then coupled to a lower portion of the housing section 220, the dual-function air cap 280 forms an internal space and performs an air pump function.

That is, as illustrated in FIG. 7, the dual-function air cap 280 is a flexible member configured to supply air by pumping, and forms an expansion space 282 by surrounding the lower portion of the housing section 220, thereby allowing air to be pumped.

In addition, the dual-function air cap 280 has a flexible capsule-shaped tip that covers the applicator 270 and is expandable. The cap is detachable and, when coupled to the lower portion of the housing section 220, participates in the generation of fragrance bubbles on the surface of the applicator 270.

In other words, to maximize portability and operational convenience of the portable perfume device, the dual-function air cap 280 may be airtightly coupled to an available space such as a side of the housing section 220 or the connector 260.

When the dual-function air cap 280 is pressed manually, the pressurized air inside the dual-function air cap 280 passes through the airflow path 221 within the housing section 220 connected to the dual-function air cap 280, then enters the connecting space 261 inside the connector 260, and is subsequently delivered to the holding space 271 within the applicator 270 through the air hole 255, which serves as an air path inside the spraying section 250.

In addition, the delivered air is discharged outside through pores of the applicator 270 while simultaneously forming fragrance-holding bubbles by carrying perfume from within the pores, which are then diffused into the air.

At this time, the connector 260 is hermetically coupled to the housing section 220 and the spraying section 250 so that the pressurized air inside the dual-function air cap 280 can be fully delivered to the applicator 270 through the connecting space 261.

Here, due to the speed of pressurization, the perfume is discharged in bubble form through the pores, thereby generating fragrance bubbles.

The faster the pressurization speed, the greater the diffusion speed of the perfume.

Fragrance bubbles contribute to enhanced fragrance diffusion by promoting the dispersion of fragrance particles more effectively than liquid perfume such as fine droplets sprayed from a conventional spray-type dispenser.

Additionally, fragrance bubbles do not detach from the applicator 270 entirely; rather, only a portion of the bubbles is exposed during pressing, and upon release of the pressure, the bubbles reabsorb into the applicator 270. As a result, fragrance is emitted only from the exposed portion.

Accordingly, compared to spray-type dispensers, unnecessary consumption of perfume is significantly reduced, and unlike spray systems where spraying efficiency decreases upon depressurization, the degree of pressurization in the present invention can be freely controlled.

Since perfume contained inside the applicator 270 is also exposed through pressurization, and the application is performed only via the outer surface of the applicator 270, the problem of perfume remaining unused and being lost into the air during storage or non-use can be solved.

In addition, fine pores may be formed in the applicator 270 to directly diffuse fragrance particles without generating fragrance bubbles.

When the applicator 270 that has generated fragrance bubbles is applied to the skin, the fragrance particles in bubble form—not liquid—are finely deposited on the skin. This provides significantly superior applicability compared to applying solid or liquid perfume such as solid-type or roll-on perfumes, and allows the same level of fragrance intensity and coverage with a smaller amount of perfume.

Therefore, in a portable perfume dispenser 200 according to another embodiment of the present invention, when the dual-function air cap 280, which is supported by the housing section 220 surrounding the perfume reservoir 210, is repeatedly pressed, the water pump 230 connected to the perfume reservoir 210 is pumped, and the perfume stored in the reservoir is discharged through the spray outlet 251, deposited onto an inner surface of the applicator 270, and wets the outer surface of the applicator 270 through its pores, allowing it to be applied or transferred onto the skin or hair.

In addition, when the dual-function air cap 280 is repeatedly pressed after being detached and then coupled to a lower portion of the housing section 220, air may flow along the airflow path 221 and be discharged into the holding space 271 through an air hole 255 formed at one side of the spraying section 250, and, together with perfume droplets deposited on an inner surface of the applicator 270, pass through pores of the applicator 270, thereby generating and releasing bubbles containing vaporized perfume on an outer surface of the applicator 270.

In conclusion, as demonstrated in the following Experimental Examples, the portable perfume dispensers 100 and 200 for both application and bubble diffusion according to the embodiments of the present invention are expected to yield significant effects in terms of applicability to skin or hair, and fragrance performance on the surface of objects, while also producing practical and measurable results.

The inventors conducted experiments in a controlled, confidential environment.

As shown in Tables 1 to 3, in the Experimental Example, a conventional 10 mL portable perfume of spray type filled with a perfume of a specific fragrance and a portable perfume of application type proposed by the present invention were applied to the inner wrists and backs of the left and right hands, respectively, either by spraying once (0.08 mL) or by applying in an equivalent amount (3-4 times). Tests were conducted to evaluate applicability, user convenience, and fragrance intensity over time.

In evaluating fragrance intensity, a sensory test was conducted in the form of a blind test.

TABLE 1

| | | | | | Fragrance Intensity | | Fragrance Intensity | |
|---|---|---|---|---|---|---|---|---|
| | | | Skin Applicability & Ease | | (Immediately After Use) | | (After 1 Hour) | |
| | Application | | of Use (1-5) | | (0-5) | | (0-5) | |
| Type | Method | Examinee | Score | Opinion | Score | Opinion | Score | Opinion |
| Nozzle | One spray | A (40s, | 2 | Sprayed mainly on a | 5 | Fragrance was so | 3 | Alcohol scent |
| Spray | | male) | | localized area and | | strong it irritated the | | mostly |
| | | | | ran down along the | | nose with an alcohol | | disappeared; mild |
| | | | | surface of the skin | | scent | | fragrance |
| | | | | | | | | remained |
| | | B (30s, | 3 | User needed to rub in | 5 | Strong alcohol smell | 3 | Alcohol scent |
| | | male) | | after spraying; | | masked the fragrance | | disappeared; decent |
| | | | | required additional | | | | fragrance different |
| | | | | effort | | | | from before |
| | | C(30s, | 2 | Nozzle misaligned | 4 | Fragrance and | 3 | Minimal alcohol |
| | | female) | | after multiple | | alcohol smell too | | scent; moderate |
| | | | | sprays, resulting in | | strong; caused a | | fragrance different |
| | | | | improper | | headache | | from before |
| | | | | application | | | | |
| PE | 3-4 | A (40s, | 5 | Applied by rubbing | 4 | Fragrance started | 3 | Mild fragrance, |
| Application | applications | male) | | the PE applicator | | gently without | | nearly same |
| | | | | while it was wet, | | irritation or alcobol | | intensity as right |
| | | | | applying and coating | | smell | | after use |
| | | | | at the same time | | | | |
| | | B (30s, | 5 | Easy to apply desired | 3 | Fragrance was | 3 | Fragrance remained |
| | | male) | | amount directly on | | slightly weaker than | | similarly without |
| | | | | skin; ideal applicator | | nozzle spray but | | further weakening |
| | | | | type | | sufficient; no alcohol | | |
| | | | | | | smell | | |
| | | C(30s, | 4 | PE held perfume | 3 | No alcohol smell; | | Similar fragrance |
| | | female) | | stably and prevented | | fragrance was | | intensity to that |
| | | | | over-application | | preferable to the | | right after |
| | | | | | | overpowering nozzle | | application |
| | | | | | | spray | | |

TABLE 2
A. Criteria for Skin Applicability and Ease of Use

| Poor | Bad | Moderate | Good | Very Good |
|---|---|---|---|---|
| 1 | 2 | 3 | 4 | 5 |

TABLE 3
B. Criteria for Intensity of Fragrance

| | Fragrance | | Fragrance | | Fragrance too |
|---|---|---|---|---|---|
| Fragrance not | perceived but | Fragrance | clearly | Strong | strong and |
| perceived | indistinct | recognizable | perceived | fragrance | irritating |
| 0 | 1 | 2 | 3 | 4 | 5 |

The above description is merely illustrative of the technical features of the present invention, and various modifications, changes, and substitutions can be made by those of ordinary skill in the art without departing from the essential characteristics of the invention. Therefore, the embodiments and the accompanying drawings disclosed herein are provided for illustrative purposes only and are not intended to limit the scope of the technical idea of the present invention. Accordingly, the scope of the technical idea of the present invention should not be construed as being limited by such embodiments and drawings.

The scope of protection of the present invention shall be defined by the claims described below, and all technical ideas falling within the equivalent scope thereof shall be construed as being included in the scope of rights of the present invention.

1. A portable perfume dispenser for both application and bubble diffusion, capable of diffusing fragrance either by surface application or by holding the fragrance in bubbles, comprising:
a perfume reservoir configured to store liquid perfume;
a flow channel support communicating with one side of the perfume reservoir;
a water pump mounted within the flow channel support and configured to pump the liquid perfume;
a nozzle connected to one end of the water pump;
a spraying section having a spray outlet in fluid communication with the nozzle;
a connector defining an internal connecting space and linking an upper portion of the flow channel support with a lower portion of the spraying section;
a porous applicator fixed to one end of the spraying section and having a holding space to space the applicator apart from the spray outlet;
an air pump configured to pump air, the air pump surrounding the flow channel support while defining an air space therebetween; and
a detachable cap housing spaced apart from the applicator and enclosing an external surface of the air pump while surrounding the flow channel support.

2. The portable perfume dispenser for both application and bubble diffusion of claim 1, configured such that with one of the perfume reservoir and the cap housing fixed and the other pressed repeatedly, the water pump is pumped via the flow channel support connected to the perfume reservoir, thereby causing the perfume stored in the perfume reservoir to be discharged through the spray outlet, deposited onto an inner surface of the applicator, and to wet an outer surface of the applicator through pores of the applicator.

3. The portable perfume dispenser for both application and bubble diffusion of claim 1, configured such that, when the air pump exposed from the cap housing is repeatedly pressed, air in the air space is discharged into the holding space through an air hole formed at one side of the spraying section, and, together with perfume droplets deposited on an inner surface of the applicator, passes through pores of the applicator, thereby generating and releasing bubbles containing vaporized perfume on an outer surface of the applicator.

4. The portable perfume dispenser for both application and bubble diffusion of claim 1, wherein the perfume reservoir is detachably coupled to one side of the flow channel support.

5. The portable perfume dispenser for both application and bubble diffusion of claim 1, wherein the flow channel support has an air path hole formed along an outer longitudinal direction thereof to communicate with the air space.

6. The portable perfume dispenser for both application and bubble diffusion of claim 1, wherein the air pump is configured to expand and contract and has a flexible doughnut-shaped body.

7. A portable perfume dispenser for both application and bubble diffusion, capable of diffusing fragrance either by surface application or by holding the fragrance in bubbles, comprising:
a perfume reservoir configured to store liquid perfume;
a housing section covering an outer side of the perfume reservoir, wherein an airflow path extending in a longitudinal direction is defined between the housing section and the perfume reservoir;
a water pump mounted within the perfume reservoir and configured to pump the liquid perfume;
a nozzle connected to one end of the water pump;
a spraying section having a spray outlet in fluid communication with the nozzle;
a connector defining a connection space and connecting an upper portion of the housing section to a lower portion of the spraying section;
a porous applicator fixed to one end of the spraying section and having a holding space to space the applicator apart from the spray outlet; and
a dual-function air cap including a cap ring detachably positioned at an upper side of the connector, the dual-function air cap surrounding the applicator while being spaced apart from the applicator.

8. The portable perfume dispenser for both application and bubble diffusion of claim 7, configured such that when the dual-function air cap, which is supported by the housing section surrounding the perfume reservoir, is repeatedly pressed, the water pump connected to the perfume reservoir is pumped, thereby causing the perfume stored in the perfume reservoir to be discharged through the spray outlet, deposited onto an inner surface of the applicator, and to wet an outer surface of the applicator through pores of the applicator.

9. The portable perfume dispenser for both application and bubble diffusion of claim 7, configured such that, when the dual-function air cap is repeatedly pressed after being detached and then coupled to a lower portion of the housing section, air flows along the airflow path and is discharged into the holding space through an air hole formed at one side of the spraying section, and, together with perfume droplets deposited on an inner surface of the applicator, passes through pores of the applicator, thereby generating and releasing bubbles containing vaporized perfume on an outer surface of the applicator.

10. The portable perfume dispenser for both application and bubble diffusion of claim 7, wherein a tip of the dual-function air cap is configured to expand and contract and is formed in a flexible capsule shape.

11. The portable perfume dispenser for both application and bubble diffusion of claim 1, wherein the spray outlet of the spraying section has a tubal shape, and a branched groove is formed at a distal end of the spray outlet so as to divide into more than one branch.

12. The portable perfume dispenser for both application and bubble diffusion of claim 1, wherein pores of the applicator have a size in a range of 5 μm to 150 μm.

13. The portable perfume dispenser for both application and bubble diffusion of claim 1, wherein a hollow dome-shaped tip extends linearly inside the applicator.

14. The portable perfume dispenser for both application and bubble diffusion of claim 1, wherein the applicator is made of one or more materials selected from porous plastic, porous ceramic, porous rubber, and porous fiber.

15. The portable perfume dispenser for both application and bubble diffusion of claim 1, wherein a packing member is interposed between the spraying section and the connector to provide sealing.

16. The portable perfume dispenser for both application and bubble diffusion of claim 1, wherein the liquid perfume includes essential oil, aroma oil, or a liquid containing fragrance.

17. The portable perfume dispenser for both application and bubble diffusion of claim 7, wherein the spray outlet of the spraying section has a tubal shape, and a branched groove is formed at a distal end of the spray outlet so as to divide into more than one branch.

18. The portable perfume dispenser for both application and bubble diffusion of claim 7, wherein pores of the applicator have a size in a range of 5 μm to 150 μm.

19. The portable perfume dispenser for both application and bubble diffusion of claim 7, wherein a hollow dome-shaped tip extends linearly inside the applicator.

20. The portable perfume dispenser for both application and bubble diffusion of claim 7, wherein the applicator is made of one or more materials selected from porous plastic, porous ceramic, porous rubber, and porous fiber.

21. The portable perfume dispenser for both application and bubble diffusion of claim 7, wherein a packing member is interposed between the spraying section and the connector to provide sealing.

22. The portable perfume dispenser for both application and bubble diffusion of claim 7, wherein the liquid perfume includes essential oil, aroma oil, or a liquid containing fragrance.
